(19) United States
(12) Patent Application Publication
(10) Pub. No.: US 2024/0228896 A1
(43) Pub. Date: Jul. 11, 2024

(54) OPTIMIZING CARBON MONOXIDE PRODUCTION FROMHETEROGENEOUS FEEDSTOCK

(71) Applicant: ENERKEM INC., Montreal (CA)

(72) Inventors: Jean-Pierre CRETE, Montreal (CA); Louis DENOMME, Montreal (CA); Frédéric ST-ONGE, Montréal (CA); Xeniya SAVELYEVA, Montréal (CA)

(21) Appl. No.: 18/559,375

(22) PCT Filed: May 5, 2022
(86) PCT No.: PCT/CA2022/050704

§ 371 Date: Nov. 7, 2023

Related U.S. Application Data
(60) Provisional application No. 63/185,482, filed on May 7, 2021.

(51) Int. Cl. C10K 3/02; C01B 3/12; C10J 3/46; C10K 1/00; C10K 1/08; C10K 1/20; C10K 3/06

(52) U.S. Cl. CPC C10K 3/026; C01B 3/12; C10J 3/46; C10K 1/005; C10K 1/08; C10K 1/20; C10K 3/06; C01B 2203/0222; C01B 2203/0244; C01B 2203/0475; C01B 2203/062; C10J 2300/0913; C10J 2300/0969; C10J 2300/1618; C10J 2300/1659; C10J 2300/1815

(57) ABSTRACT

It is provided a process for increasing production of carbon monoxide (CO) and recycling carbon dioxide when treating synthesis gas using a carbon dioxide-to-carbon monoxide conversion unit, such as a Reverse Water Gas Shift (RWGS) reactor, converting excess CO₂ from the produced syngas to additional CO, using an external source of green, renewable or low carbon intensity hydrogen.

### TECHNICAL FIELD

It is disclosed a process for increasing production of carbon monoxide (CO) and recycling carbon dioxide when treating synthesis gas using a carbon dioxide-to-carbon monoxide conversion unit, while balancing carbon dioxide requirements.

### BACKGROUND

With increasing demand in the industry for carbon recycling (circular economy), it is of great interest to use carbonaceous material such as biomass, waste or plastic in the production of syngas. Such syngas can be further utilized for the production of alcohols, liquid fuel and many other chemicals. It is well known in the industry that syngas production with conventional methods such as partial oxidation, gasification and/or reforming, from a solid, liquid or gaseous carbonaceous feedstock generates mainly H₂, CO and CO₂ at various concentration. The ratio of H₂/CO and CO/CO₂ will vary depending on the process, its efficiency and feedstock characteristic.

Only few syngas conversion catalysts allow to achieve very high carbon recycling via the reaction of both CO and CO₂. For example, methanol catalysts are able to achieve high carbon efficiency with their ability to also convert CO₂+H₂ to methanol.

$$CO + 2 {H}_{2} ↔ C {H}_{3} OH \qquad ( 1 )$$

$${CO}_{2} + {H}_{2} ↔ CO + {H}_{2} O \qquad ( 2 ) ( Reverse WGS )$$

$${CO}_{2} + 3 {H}_{2} ↔ C {H}_{3} OH + {H}_{2} O \qquad ( 3 )$$

Integration of methanol syngas conversion technology with biomass to syngas, waste to syngas or plastic to syngas production technology allow to achieve very high carbon recycling via both CO and CO₂ conversion with an external source of hydrogen. This is especially of interest where green or low carbon intensity H₂ is available for integration into a biorefinery.

For many syngas conversion catalysts and processes, CO₂ will not be converted into the final product and, in the worst case, CO₂ will be generated via the water-gas shift (WGS) reaction (equation (5)) or other side reactions. For example, it is well known in the industry that current commercially available Cobalt (Co) based Fischer Tropsch (FT) catalysts cannot make FT liquid/paraffin/wax, etc. directly from CO₂ and H₂, i.e. their stoichiometry is based on CO+H₂ chemistry (per equation 4):

$$CO + 2 {H}_{2} \text{-->} - {CH}_{2 -} + {H}_{2} O \qquad ( 4 )$$

Most mature industrial scale FT technology provider uses Co based FT catalyst.

On the other end, iron (Fe) based FT catalyst does have good WGS activity (equation 5) to shift excess CO with H₂O to extra H₂, thus allowing to rebalance the syngas H₂/CO ratio to the required FT ratio of 2 (per equation 5). However, limited data are available on CO₂+H₂ feed to Fe based FT catalyst to produce FT product. No industrial scale application is yet available.

$$CO + {H}_{2} O ↔ {CO}_{2} + {H}_{2} \qquad ( 5 ) ( WGS )$$

Therefore, a cobalt based FT biorefinery would have to manage separately the potential to convert excess CO₂ with H₂ to CO for feeding to a FT reactor. This needs to be accomplished via the Reverse Water Gas Shift (RWGS) as shown in equation 2 above, or other techniques to convert CO₂ to CO. One such alternative technique is CO₂ electrolysis to CO and O₂ or CO₂+H₂O co-electrolysis to H₂+CO and O₂, as per the following reactions:

$${CO}_{2} electrolysis :$$

$${CO}_{2} + electricity \to CO + 1 / 2 {O}_{2} \qquad ( 6 )$$

$${CO}_{2} + {H}_{2} O co - electrolysis :$$

$${CO}_{2} + {x H}_{2} O + electricity \to CO + {x H}_{2} + \frac{1 + x}{2} {O}_{2} \qquad ( 7 )$$

RWGS is currently not (or only to a limited extent) conducted at full scale in the industry. It requires high temperature (>600 to >900° C.) to get favorable equilibrium toward CO. One of the mains challenges is also to get a catalyst active for the RWGS reaction, but not for the methanation reaction (equation below).

$$CO + 3 {H}_{2} \to {CH}_{4} + {H}_{2} O \qquad ( 8 )$$

$${CO}_{2} + 4 {H}_{2} \to {CH}_{4} + 2 {H}_{2} O \qquad ( 9 )$$

The methanation reaction thermodynamic equilibrium is favored at lower temperature and higher pressure. Therefore, RWGS operation at higher temperature offer an additional advantage of thermodynamically limiting the extent of the methanation reaction and resulting reactant loss, but do offer additional challenge to achieve an energy efficient process at such temperature. R&D works and efforts are being invested to develop RWGS catalyst with no to limited methanation selectivity at lower temperature (ex. 500-600° C.), but not yet available at commercial scale and not demonstrated for longer term stability and performance. Although lower RWGS reaction temperature helps on the thermal efficiency side, single pass CO₂ conversion are lower, which involves higher CO₂ and/or H₂ recycle ratio and larger separation unit, and thus higher energy and electricity consumption.

In a gasification process, the syngas is generally composed of H₂, CO and CO₂. The CO₂ is typically removed prior to FT synthesis, and even for synthesis of oxygenates.

Higher temperature range RWGS can be conducted with catalyst (ex. Ni based) in either an SMR type reactor (roughly isothermal, externally heated) or autothermal reforming (ATR) type reactor. Alternatively, the feed H₂+CO₂ could be pre-heated to sufficiently high temperature (ex. above 800-900° C.) to be feed to an adiabatic fixed bed reactor since the RWGS endothermic heat of reaction is relatively low. Also known is an auto thermal catalytic approach with methanation co-reaction providing the heat for the RWGS reaction, but has the disadvantage of having to separate CH₄ from the CO effluent.

Alternatively, the RWGS reaction can be conducted without catalyst at higher temperature (up to 1500° C.), but at such temperature, a refactorized reactor is required (e.g. POX type).

Even in the high temperature range, the extent of CO₂ conversion to CO is somewhat limited and either require large excess of hydrogen that needs to be separated downstream and recycled and/or CO₂ removal and recycle.

Therefore, there is still a need to be provided with a cost effective RWGS reaction systems design and development and its integration in a specific plant design and operation.

### SUMMARY

It is provided a process for increasing production of carbon monoxide (CO) and recycling carbon dioxide when treating synthesis gas comprising the steps of passing a first synthesis gas stream comprising hydrogen, carbon monoxide and carbon dioxide through a first separation zone, thereby separating the first synthesis gas stream into a second stream comprising hydrogen and carbon monoxide, and a third stream comprising carbon dioxide; feeding the third stream to a carbon dioxide-to-carbon monoxide conversion unit, producing a fourth stream comprising carbon monoxide and a fifth stream comprising oxygen; mixing the second stream and the fourth stream producing a syngas product stream; and feeding the syngas product stream into a product synthesis unit.

It is also provided a process for increasing production of carbon monoxide (CO) and recycling carbon dioxide when treating synthesis gas comprising the steps of passing a first synthesis gas stream, the first synthesis gas stream comprising hydrogen, carbon monoxide and carbon dioxide through a first separation zone, thereby separating the first synthesis gas stream into a second stream comprising hydrogen and carbon monoxide, and a third stream comprising carbon dioxide; combining the third stream with a hydrogen stream generating a fourth stream comprising carbon dioxide and hydrogen; feeding the fourth stream into a carbon dioxide-to-carbon monoxide conversion unit consisting of a Reverse Water Gas Shift (RWGS) reactor to produce a fifth stream comprising carbon monoxide, hydrogen and unreacted carbon dioxide; passing the fifth stream to a second separation zone for removing the unreacted carbon dioxide and producing a CO₂ depleted syngas stream, wherein the unreacted carbon dioxide is recycled back into the third stream for combining with the hydrogen stream and feeding into the RWGS reactor; combining the H₂ and CO from the second stream and H₂ and CO from the CO₂ depleted syngas stream producing a syngas product stream; and feeding the syngas product stream into a product synthesis unit.

In an embodiment, the second separation zone is combined with the first separation zone, wherein the fifth stream RWGS reactor product is recycle back into the first separation zone, recovering in-situ the CO₂ from the fifth and first streams and producing the third stream comprising carbon dioxide from both streams.

In another embodiment, the H₂ and CO from the fifth stream is combined within the first separation zone with the H₂ and CO from the first stream, producing the second stream comprising hydrogen and carbon monoxide producing the syngas product stream which is fed into the product synthesis unit.

In an embodiment, the process described herein further comprises mixing the syngas product stream with additional hydrogen for adjusting the stoichiometric ratio requirement of the product synthesis unit.

In another embodiment, the product synthesis unit is a Fischer Tropsch reactor.

In an additional embodiment, the first and second separation zone comprises a CO₂ selective solvent, a CO₂ adsorption step and a solvent regeneration step to produce the desired carbon dioxide streams.

In an embodiment, the CO₂ selective solvent is methanol, ethanol, N-Methyl-2-pyrrolidone (NMP), amine, propylene carbonate, dimethyl ether of polyethylene glycol (DMPEG), methyl isopropyl ether of polyethylene glycol (MPEG), tributyl phosphate, or sulfolane.

In a supplemental embodiment, all or a portion of said hydrogen stream is used as a stripping gas to extract CO₂ from the CO₂ selective solvent in the first separation zone including hydrogen in the third stream, comprising carbon dioxide, and reducing the amount of said hydrogen to generate the fourth stream.

In an embodiment, all or a portion of said hydrogen stream is used as a stripping gas to extract CO₂ from the CO₂ selective solvent in the second separation zone thus generating unreacted carbon dioxide RWGS stream and additional hydrogen.

In a further embodiment, the first and second separation zone comprises at least one membrane which is permeable to carbon dioxide and retains hydrogen and/or carbon monoxide.

In a further embodiment, the first and second separation zone comprises at least one PSA or VPSA system which removes carbon dioxide and carbon monoxide from hydrogen producing an hydrogen rich stream and which releases carbon dioxide and carbon monoxide in a lower pressure stream.

In an embodiment, an effluent comprising water is produced from the RWGS reactor.

In another embodiment, the RWGS reactor effluent is cooled to condense and separate the water generated by the RWGS reaction.

In an embodiment, the carbon dioxide-to-carbon monoxide conversion unit is either a CO₂ electrolysis unit, or a CO₂+H₂O co-electrolysis unit.

In another embodiment, the RWGS reactor is a heated catalytic multitube reactor design, an autothermal catalytic reactor, a fixed bed adiabatic catalytic reactor, or a combination thereof.

In a further embodiment, the RWGS reactor comprises a nickel catalyst or an iron based catalyst.

In an embodiment, the RWGS reactor is a high temperature autothermal POX type reactor, with no catalyst.

In a further embodiment, the first synthesis gas stream is produced from partial oxidation, gasification and/or reforming of a carbonaceous feedstocks.

In an embodiment, the carbonaceous material comprises a plastic, a metal, an inorganic salt, an organic compound, industrial wastes, recycling facilities rejects, automobile fluff, municipal solid waste, ICI waste, C&D waste, refuse derived fuel (RDF), solid recovered fuel, sewage sludge, used electrical transmission pole, railroad ties, wood, tire, synthetic textile, carpet, synthetic rubber, materials of fossil fuel origin, expended polystyrene, poly-film floc, construction wood material, or any combination thereof.

In another embodiment, the source of hydrogen is from a renewable source and/or a source of low carbon intensity.

In an additional embodiment, the source of hydrogen is from a water electrolysis with renewable power or low carbon intensity power, a biogas reforming, a steam reforming, a low carbon intensity (CI) blue hydrogen source, or a low CI waste H₂ source.

In an embodiment, the process encompassed herein further comprises admixing to the third stream an external input of CO₂ or CO₂ input obtained from another process effluent, increasing the CO₂ flow rate upstream of the CO₂ to CO conversion unit thereby, increasing the flow rate of CO in the syngas product stream.

In an embodiment, the process encompassed herein further comprises admixing to the third stream a reformed low carbon intensity (CI) carbon rich stream, increasing the carbon content upstream of the CO₂ to CO conversion unit thereby, increasing the flow rate of CO in the syngas product stream.

In an embodiment, the carbon rich stream is a waste gas or liquid from the product synthesis unit.

In another embodiment, the carbon rich stream is a gas or liquid from an external source.

In an embodiment, the carbon rich stream is reformed or partially oxidized at high temperature upstream of the RWGS unit producing additional syngas, and wherein the hot reformed waste stream is mixed at the inlet of the RWGS unit to provide all or part of the heat required for the endothermic RWGS reactor, reducing the energy requirement of the process.

In an embodiment, the carbon rich stream is reformed at high temperature upstream of the RWGS unit.

In another embodiment, the carbon rich stream is reformed at more than 900° C. upstream of the RWGS unit.

In another embodiment, the reforming step is conducted in a reforming unit.

In another embodiment, the reforming unit is an autothermal catalytic reactor, a high temperature autothermal POX type reactor, or a dry reforming reactor.

It is also provided a process for increasing production of carbon monoxide (CO) and recycling carbon dioxide when treating synthesis gas comprising the steps of gasifying a carbonaceous material in a fluidized bed, producing a classified crude syngas; reforming the classified crude syngas at a temperature above mineral melting point, producing reformed synthesis gas comprising hydrogen, carbon monoxide and carbon dioxide; passing the reformed synthesis gas through a first separation zone, thereby separating the first synthesis gas stream into a second stream comprising hydrogen and carbon monoxide, and a third stream comprising carbon dioxide; and recycling the third stream comprising carbon dioxide to the fluidized bed gasifier, with or without steam and/or O₂ to reduce the reformed synthesis gas H₂/CO ratio, and increasing the total CO yield and production.

In an embodiment, the second stream comprising hydrogen and carbon monoxide further comprises residual carbon dioxide; is passed through a second separation zone, thereby separating said second synthesis gas into a fourth stream comprising hydrogen and carbon monoxide, and a fifth stream comprising carbon dioxide; combining the fifth stream with a hydrogen stream generating a sixth stream comprising carbon dioxide and hydrogen; feeding the sixth stream into a carbon dioxide-to-carbon monoxide conversion unit consisting of a Reverse Water Gas Shift (RWGS) reactor to produce a seventh stream comprising carbon monoxide, hydrogen and unreacted carbon dioxide; passing said seventh stream to a third separation zone for removing the unreacted carbon dioxide and producing a CO₂ depleted syngas stream, wherein the unreacted carbon dioxide is recycled back into the fifth stream for combining with the hydrogen stream and feeding into the RWGS reactor; combining the fourth stream and the CO₂ depleted syngas stream producing a syngas product stream; and feeding the syngas product stream into a product synthesis unit.

In an embodiment, the process described herein further mixing the syngas product stream with additional hydrogen for adjusting the stochiometric ratio requirement of the product synthesis unit.

In another embodiment, the first, second and third separation zones comprises a CO₂ selective solvent, a CO₂ adsorption step and a solvent regeneration step to produce the desired carbon dioxide streams.

In a further embodiment, the first, second and/or third separation zones are combined in a single separation zone.

In an embodiment, the hydrogen stream is used as a stripping gas to extract CO₂ from the CO₂ selective solvent in the first separation zone, second separation zone and/or third separation zone.

In an additional embodiment, the first, second and third separation zone comprises at least one membrane which is permeable to carbon dioxide and retains hydrogen and/or carbon monoxide

In an embodiment, the first, second and third separation zone comprises at least one PSA or VPSA system which removes carbon dioxide and carbon monoxide from hydrogen producing an hydrogen rich stream and which releases carbon dioxide and carbon monoxide in a lower pressure stream.

In an embodiment, the waste gas or liquid from the product synthesis unit are recycled at the gasification and/or reforming steps.

### BRIEF DESCRIPTION OF THE DRAWINGS

Reference will now be made to the accompanying drawings.

FIG. 1 illustrates a schematic representation of the process integrating RWGS steps in accordance to an embodiment.

FIG. 2 illustrates a schematic representation of an alternative process comprising one single CO₂ separation zone in accordance to an embodiment.

FIG. 3 illustrates a schematic representation of an alternative process wherein the recovered CO₂ and/or the waste gas and/or waste liquid can be recycled at the gasification and reforming step in accordance to an embodiment.

It will be noted that throughout the appended drawings, like features are identified by like reference numerals.

### DETAILED DESCRIPTION

In accordance with the present disclosure, there is provided a process for increasing production of carbon monoxide (CO) and recycling carbon dioxide when treating synthesis gas using a carbon dioxide-to-carbon monoxide conversion unit.

It is provided a mean to optimize the amount of carbon recycling of waste materials by minimizing the amount of CO₂ required for inertizing and pressurizing feedstock, isolate a CO₂ rich stream, and convert the CO₂ rich stream into CO to further synthesize FT products. As encompassed herein, any hydrocarbon waste streams can be converted into additional syngas which will further increase the amount of CO available, which will further increase the carbon recycling.

It is provided a method for maximizing yield of CO derived from partial oxidation, gasification and/or reforming carbonaceous feedstock with the integration of a Reverse Water Gas Shift (RWGS) unit, or alternative CO₂ conversion to CO unit, to convert excess CO₂ from the produced syngas to additional CO, when an external source of green, renewable or low carbon intensity hydrogen is available.

Several carbonaceous solid, liquid or gas feedstock partial oxidation, gasification and/or reforming end up generating a crude syngas streams with an H₂/CO ratio lower then 2.0, which is required per stoichiometry for the production of methanol, other alcohol and/or hydrocarbons (i.e. Fischer Tropsch). The H₂/CO ratio generated from these processes are often below 1.5 and even as low as 0.7 and below. In partial oxidation, gasification and/or reforming processes, in addition to H₂ and CO, CO₂ is always produced and it will be present at various concentration in the crude syngas depending on the process efficiency and feedstock heating value.

In coal or liquid fossil fuel gasification and/or reforming plants producing a crude syngas with an H₂/CO lower than that required per the ratio derived from the stoichiometric reactions of the desired end product, a water gas shift reactor is typically included in the plant design to shift a portion of the excess CO into additional H₂ to rebalance the overall plant H₂/CO ratio (per reaction 5 above), or alternatively, in situ shifted to additional H₂ in the desired project syngas synthesis reactor, for example, with Fe-based Fischer Tropsch). Since the overall plant has an excess of CO₂, a process unit is required for CO₂ removal. Since those feedstocks also typically contain sulfur which are converted into reduced sulfur species (H₂S, COS, etc.) in the gasification and/or reforming units, such typical plant also contains an acid gas removal (AGR) unit that removes both CO₂ and sulfur reduced species. Reduced sulfur species are poisons for several syngas conversion catalysts and are also undesired in most final chemical and/or biofuel products.

In biomass rich or waste gasification and/or reforming valorization plant, such approach has the negative impact of losing valuable biogenic carbon via the carbon monoxide shift, which does not end-up in the final biogenic product, but rather as excess CO₂ that the plant has to either valorized as very low value merchant CO₂ and/or safely release it to atmosphere after treatment and increase the greenhouse gas impact of the plant.

It has been documented that rather than shifting excess CO to H₂ in such a plant using biobased carbonaceous feedstock, an external source of hydrogen could be imported into the plant and combined with the plant rich CO bio-syngas to rebalance the overall plant H₂/CO ratio to that required for the stoichiometric reactions of the desired end product.

It is also known that some chemicals and biofuel can be produced from the reaction of H₂ and CO, but also from H₂ and CO₂. One such product is methanol, but also Fischer Tropsch using iron based catalyst and ethanol using micro-organism bio-catalyst. However, other type of synthesis catalyst does not offer this ability, including Co-based Fischer Tropsch catalyst as explained before. Similarly, in the chemical industry, acetic acid is produced from the carbonylation of methanol and CO, and cannot be directly produced from CO₂.

Accordingly, it is provided a mean to maximize overall carbon feedstock conversion to the final desired chemical or fuel, for example, without being limited to, using Co-based catalyst Fischer Tropsch production from biomass, biomass rich waste and/or waste plastic gasification and/or reforming.

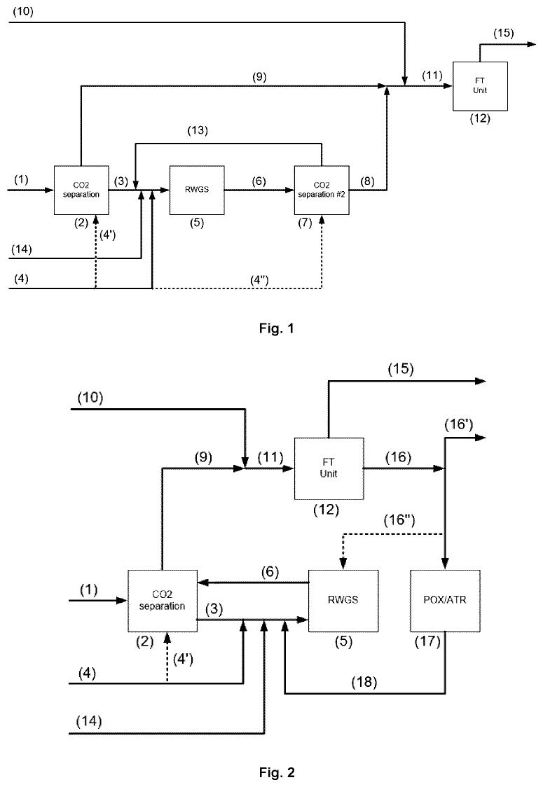

As seen in FIG. 1, a syngas stream (1) is provided with an H₂/CO ratio lower than 2 and with excess CO₂ as produced by most carbonaceous feedstock gasification and/or reforming process.

An external input of hydrogen (4) is provided from an external source (i.e. not generated from the same syngas generation unit) in quantity and ratio sufficient to fully convert the desired amount of excess CO₂ to additional CO (per reaction 2).

The CO₂ rich syngas (1) is sent to a first CO₂ separation zone (2) to produce a CO₂ depleted syngas (H₂+CO rich) (9) and a rich CO₂ stream (3). This said rich CO₂ stream (3) is then mixed with a portion of or the entire external hydrogen stream (H₂ import #1) (4), and then feed to a RWGS unit (5) to convert the CO₂ to CO, thus producing a new syngas stream (6). The RWGS reactor effluent is first cooled to condense and separate the water generated by the RWGS reaction and then fed to a second CO₂ separation zone (7) to remove and recycle unconverted CO₂ (13) to the RWGS unit (5). As an alternative, portions of the H₂ import (4′ and/or 4″) can be feed to the first and/or second CO₂ separation zone (2) and (7) for use as stripping gas when using a solvent based CO₂ removal unit as described below. It is encompassed that external CO₂ or CO₂ input from another process effluent (14) can be mixed with the CO₂ rich stream (3) upstream of the RWGS unit (5) to further increase the production of CO. The flow of the external source of hydrogen (4) must be increased accordingly.

As encompassed herein, the CO₂ separation zone comprises a solvent based scrubbing system with a solvent selective for carbon dioxide absorption or CO₂ selective solvent; a CO₂ absorption step and a solvent regeneration step to produce the desired carbon dioxide streams. In an embodiment, the CO₂ selective solvent is e.g., but not limited to, methanol, ethanol, N-Methyl-2-pyrrolidone (NMP), amine, propylene carbonate, dimethyl ether of polyethylene glycol (DMPEG), methyl isopropyl ether of polyethylene glycol (MPEG), tributyl phosphate, or sulfolane. Alternatively to a solvent based CO₂ separation zone, the first and second separation zone described herein can also comprise a membrane unit which is permeable to carbon dioxide and retains hydrogen and/or carbon monoxide. Other alternative CO₂ separation zone, but not limited to, may include a solid adsorbent system for selective adsorbtion of CO₂ and/or CO with pressure or thermal swing technique.

The new CO₂ depleted syngas stream or syngas product (8) from the RWGS and CO₂ separation zone is then combined with the above CO₂ depleted syngas (9) to be fed to the desired product synthesis unit (12), such as e.g. but not limited to a Fischer Tropsch reactor. If required, the balance of the external hydrogen import ((H₂ import #2) (10) is combined to both CO₂ depleted syngas stream to rebalance the overall plant H₂/CO ratio to that required per the ratio derived from the stoichiometric reactions of the desired end product, which as exemplified herein is a Fischer Tropsch product produced from reaction 4.

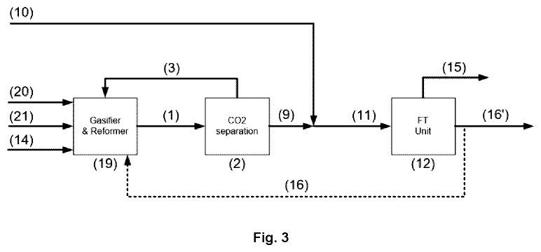

The product synthesis unit (12) converts the H₂ adjusted CO₂ depleted syngas (11) into the final product (15). It is encompassed that waste gas and/or waste liquid (16) from the product synthesis unit can be recycled through a reforming unit such as an autothermal catalytic reactor (e.g. ATR) or a high temperature autothermal POX type reactor (non-catalytic) (17), or dry reforming reactor, but not limited to (see FIG. 2). The hot (e.g. >900° C.) reformed waste stream (18) can be mixed at the inlet of the RWGS unit (5) to provide all or part of the heat required for the endothermic RWGS reactor, and thus reducing the energy requirement of the entire process. It is also encompassed that waste gas and/or waste liquid can be recycled at the gasification and reforming step (19) (as shown in FIG. 3). This allows recycling of the carbon from the waste stream (16) thereby increasing the production of CO and improve the overall efficiency. A portion of the waste stream (16′) can be purged to avoid accumulation of inert gases. It is also encompassed that the waste stream (16) can be used as fuel (16″) in the RWGS unit (5), for example in a RWGS reactor feed pre-heater (fired type). Alternatively, an energy source of low carbon intensity (i.e. GHG emission) such as renewable fuel and/or renewable electricity can be used to provide heat in the RWGS unit.

In an embodiment, the RWGS reactor encompassed herein is an externally heated catalytic multitube reactor design, an autothermal catalytic reactor (ATR type with oxygen injection to further increase the feed temperature prior to the adiabatic RWGS reactor catalyst bed) or a fixed bed adiabatic catalytic reactor, or any combinations thereof. The catalyst in the RWGS reactor can be a nickel or an iron based catalyst, but not limited to. It is also encompassed that the RWGS reactor described herein may also be a high temperature autothermal POX type reactor, with oxygen injection similar to the ATR type, but with no catalyst.

It is also encompassed that the external source of hydrogen can be produced from a renewable source and/or low carbon intensity (i.e. GHG emission), including but not limited to water electrolysis with renewable power, biogas reforming or steam reforming, or low carbon intensity (CI) blue hydrogen (fossil fuel methane reforming with CO₂ capture), low CI waste H₂, etc.

As encompassed herein, the syngas stream originate from gasification of a carbonaceous material. The carbonaceous materials encompassed herein can be biomass-rich materials which may be gasified as described in International application no. PCT/CA2020/050464, the content of which is incorporated by reference in its entirety, and include, but are not limited to, homogeneous biomass-rich materials, non-homogeneous biomass-rich materials, heterogeneous biomass-rich materials, and urban biomass. The carbonaceous material can also be plastic rich residues or any waste/product/gas/liquid/solid that include carbon. It may also be any type of coal and derivative such as pet coke, petroleum product & by-product, waste oil, oily fuel, hydrocarbon and tar.

Homogeneous biomass-rich materials are biomass-rich materials which come from a single source. Such materials include, but are not limited to, materials from coniferous trees or deciduous trees of a single species, agricultural materials from a plant of a single species, such as hay, corn, or wheat, or for example, primary sludge from wood pulp, and wood chips. It may also be materials from refined single source like waste cooking oil, lychee fruit bark, etc.

Non-homogeneous biomass-rich materials in general are materials which are obtained from plants of more than one species. Such materials include, but are not limited to, forest residues from mixed species, and tree residues from mixed species obtained from debarking operations or sawmill operations.

Heterogeneous biomass-rich materials in general are materials that include biomass and non-biomass materials such as plastics, metals, and/or contaminants such as sulfur, halogens, or non-biomass nitrogen contained in compounds such as inorganic salts or organic compounds. Examples of such heterogeneous biomass-rich materials include, but are not limited to, industrial wastes, recycling facilities rejects, automobile fluff and waste, urban biomass such as municipal solid waste, such as refuse derived fuel (RDF), solid recovered fuel, sewage sludge, tire, synthetic textile, carpet, synthetic rubber, expended polystyrene, poly-film floc, used wood utility poles and wood railroad ties, which may be treated with creosote, pentachlorophenol, or copper chromium arsenate, and wood from construction and demolition operations which may contain one of the above chemicals as well as paints and resins.

As encompassed herein, the syngas stream which originate from gasification of a carbonaceous material, also require additional conditioning and treatment to become suitable for the product synthesis unit.

As described above, an AGR unit and a guard bed filter are utilized upstream of the product synthesis unit in order to reach very low contaminant level in the syngas. The AGR unit also has the ability to remove a portion of the CO₂ from the sour syngas and generates a non-flammable CO₂ stream suitable for pressurization and inertization of the carbonaceous feedstock at the gasification step but also for other purges requiring an inert gas.

Up-stream of the AGR, also as described in International application no. PCT/CA2020/050464, the gasification plant may also include a feeding system to feed the carbonaceous material into a fluidized bed gasifier, thus producing a crude syngas which is then thermally reformed at temperature above the carbonaceous material ashes (mineral) melting point, thus producing the reformed syngas (synthetic gas). In an embodiment, the fluidizing agent is air, oxygen, carbon dioxide, nitrogen, steam or any combination in any proportion thereof. The gasification plant may also include hot reformer syngas quench cooling and heat recovery, and include additional cleaning stages including particle removal, ammonia removal, chlorine removal, other catalyst poison removal via for example wet water scrubbers.

In an embodiment, carbonaceous materials can be fed as low density fluff RDF by a feeding system, lowering the costs of the pre-treatment of the feedstock by only partially pre-treating the RDF fluff. In another embodiment, carbonaceous materials can be a mixture of low density fluff having a particle size ranging from a few millimeters to many centimeters. In a non-limiting embodiment, carbonaceous materials can be in high density pelletized form with or without low density fluff. In another non limiting embodiment, carbonaceous materials can be a solid, liquid, gas or any composition in any proportion thereof that contain the carbon atom. In all cases the non-flammable CO₂ stream extracted from the AGR can be used as low cost inert gas for pressurization and inertization of the carbonaceous feedstock at the gasification step. The uses of CO₂ as inertization gas, not only remove O₂ trapped in the bulk carbonaceous material feedstock to make it safe for injection in the gasifier, but also remove trapped N₂ which would reduce the downstream syngas partial pressure in the product synthesis unit, and thus increase inert and non-condensable gases purge rate and losses of valuable syngas, and resulting in lower desired product yield.

In an embodiment, as seen in FIG. 3, the additional AGR extracted CO₂ (3) can be recycled to the fluid bed gasifier (19) to be used as a fluidization agent and/or in combination with steam (20) and/or oxygen (21) to allow to adjust and optimize the reformed syngas H₂/CO ratio. In another non limiting embodiment, such CO₂ fluidization agent can be another CO₂ sources extracted from the plant, and/or an external CO₂ sources (14). Higher CO₂ to steam ratio in the gasifier fluid bed allow to maximize CO yield and thus FT product yield. It is encompassed that these steps can be used with and without the combination of the current RWGS integration described herein.

The ratio or flow rate of H₂ import #1 (4) depends on the amount of excess CO₂ to be converted to CO and to achieve high efficiency in the RWGS unit. A distinguishing feature of the process provided herewith is to take advantage of the additional total H₂ import required at the plant, which also include the H₂ required to convert the CO load from the original syngas stream (1). Thus, this new integrated process takes advantage of this additional importation of H₂ to use it, at least partially, in the RWGS unit to optimize the CO₂ single pass conversion and reduce the size, CAPEX and energy consumption related to the CO₂ removal and recycle steps, and eliminate the need for an H₂ separation steps, which further reduce CAPEX and energy consumption.

Table 1 below shows an example of the split between H₂ import #1 (4) and #2 (10), syngas stream at different CO₂ level. For simplicity, an H₂/CO ratio of 1 have been fixed for all cases and on the basis of 100 kmol/h of syngas, and assuming 100% CO₂ removal and recycle (although in practice up to about 95% would apply).

TABLE 1
RWGS integration CO production increase

| | | | | | | 30% + |
|---|---|---|---|---|---|---|
| Stream | % v CO₂ | 10% | 15% | 25% | 30% | external CO₂ |
| 1 | % v CO₂ | 10% | 15% | 25% | 30% | 50% |
| | % v CO | 45% | 42.5% | 37.5% | 35% | 25% |
| | % v H₂ | 45% | 42.5% | 37.5% | 35% | 25% |
| | Syngas reference | 100 | 100 | 100 | 100 | 100 |
| | flow rate (kmol/h) | | | | | |
| | CO₂ - kmol/hr | 10 | 15 | 25 | 30 | 30 |
| | CO - kmol/hr | 45 | 42.5 | 37.5 | 35 | 35 |
| | H₂ - kmol/hr | 45 | 42.5 | 37.5 | 35 | 35 |
| 14 | External CO₂ | 0 | 0 | 0 | 0 | 40 |
| | import | | | | | |
| — | Total available | 10 | 15 | 25 | 30 | 70 |
| | CO₂ to RWGS | | | | | |
| — | Extra CO | 10 | 15 | 25 | 30 | 70 |
| | production | | | | | |
| | from RWGS | | | | | |
| | (kmol/h) | | | | | |
| 4 | H₂ import #1 | 20 | 30 | 50 | 60 | 140 |
| | (kmol/hr)^{a} | | | | | |
| 10 | H₂ import #2 | 55 | 57.5 | 62.5 | 65 | 105 |
| | (kmol/h)^{a} | | | | | |
| — | Total H₂ Import | 75 | 87.5 | 112.5 | 125 | 245 |
| | (kmol/h) | | | | | |
| 11 | Total CO plant | 55 | 57.5 | 62.5 | 65 | 105 |
| | production | | | | | |
| | (kmol/h) | | | | | |
| | % increase CO | 122% | 135% | 167% | 186% | 300% |
| | production^{b} | | | | | |
| 16 | FT product yield | 122% | 135% | 167% | 186% | 300% |
| | increase^{b} | | | | | |

^{a}Total H₂ based on desired H₂/CO ratio of 2.0 fed in the final syngas stream fed to the downstream syngas conversion unit to the desired end product. The split between H₂ import #1 and #2, depends on the extent of single pass CO2 conversion to CO in the RWGS, which is turn depends on the H₂/CO₂ ratio feed to the RWGS unit and reactor operating temperature. For the purpose of demonstrating this invention, a high temperature RWGS have been used.
^{b}% increase CO production is “Total CO plant production (kmol/h)”divided by CO in Reference fed syngas (kmol/h). FT product yield increase is proportional to CO production increase.

Alternatively, the first and second CO₂ separation zone can be combined into one single CO₂ separation zone (FIG. 2), which further reduce the CAPEX of this novel design. Another alternative can be the combination of the first and/or second CO₂ separation zone with the AGR, followed by guard bed filters on the CO₂ stream (3) and CO₂ depleted syngas stream (9) to remove trace contaminants in both streams.

In a further embodiment, other CO₂ to CO conversion technology could be integrated such as for example CO₂ electrolysis to CO and O₂ or CO₂+H₂O co-electrolysis to H₂+CO and O₂, as presented before (equation 6 and 7). In case of CO₂ electrolysis, the import of H₂ #1 (4) would be zero, and all the total H₂ import would be fed via the H₂ Import #2 (10). In case of CO₂+H₂O co-electrolysis, the import of H₂ #1 (4) would also be zero, and the total H₂ import fed via H₂ import #2 (10) would be reduced by the amount of H₂ generated by the co-electrolysis step.

Several different methods can be used for the CO₂ separation steps. It can be CO₂ selective membrane separation technology, for example Polaris from MTR or PIX from Air Liquid. It can be an amine CO₂ solvent process with a CO₂ adsorption steps and a CO₂ recovery steps from the solvent regeneration. In a preferred alternative, chilled methanol is used as a solvent. In a further preferred alternative, a simple chilled methanol pressure swing CO₂ absorption/desorption can be implemented, and using the import #1 hydrogen (stream 4′ and/or 4″) as a CO₂ stripping gas which further reduce the energy consumption requirement of the CO₂ removal steps.

While the present disclosure has been described in connection with specific embodiments thereof, it will be understood that it is capable of further modifications and this application is intended to cover any variations, uses, or adaptations and including such departures from the present disclosure as come within known or customary practice within the art to and as may be applied to the essential features hereinbefore set forth, and as follows in the scope of the appended claims.

1. A process for increasing production of carbon monoxide (CO) and recycling carbon dioxide when treating synthesis gas comprising the steps of:
passing a first synthesis gas stream comprising hydrogen, carbon monoxide and carbon dioxide through a first separation zone, thereby separating said first synthesis gas stream into a second stream comprising hydrogen and carbon monoxide, and a third stream comprising carbon dioxide;
feeding said third stream to a carbon dioxide-to-carbon monoxide conversion unit, producing a fourth stream comprising carbon monoxide, and a fifth stream comprising oxygen;
mixing said second stream and the fourth stream producing a syngas product stream; and
feeding the syngas product stream into a product synthesis unit.

2. The process of claim 1, further comprising
combining said third stream with a hydrogen stream generating a fourth stream comprising carbon dioxide and hydrogen;
feeding said fourth stream into the carbon dioxide-to-carbon monoxide conversion unit consisting of a Reverse Water Gas Shift (RWGS) reactor to produce a fifth stream comprising carbon monoxide, hydrogen and unreacted carbon dioxide;
passing said fifth stream to a second separation zone for removing the unreacted carbon dioxide and producing a CO₂ depleted syngas stream, wherein the unreacted carbon dioxide is recycled back into the third stream for combining with the hydrogen stream and feeding into the RWGS reactor; and
combining the H₂ and CO from the second stream and H₂ and CO from the CO₂ depleted syngas stream producing a syngas product stream.

3. The process of claim 2, where the second separation zone is combined with the first separation zone, wherein the fifth stream RWGS reactor product is recycle back into the first separation zone, recovering in-situ the CO₂ from the fifth and first streams and producing the third stream comprising carbon dioxide from both streams.

4. The process of claim 3, wherein the H₂ and CO from the fifth stream is combined within the first separation zone with the H₂ and CO from the first stream, producing the second stream comprising hydrogen and carbon monoxide producing the syngas product stream which is fed into the product synthesis unit.

5. The process of claim 2, further comprising mixing the syngas product stream with additional hydrogen for adjusting the stochiometric ratio requirement of the product synthesis unit.

6. The process of claim 1, where the product synthesis unit is a Fischer Tropsch reactor.

7. The process of claim 2, where said first and second separation zone comprises a CO₂ selective solvent, a CO₂ adsorption step and a solvent regeneration step to produce the desired carbon dioxide streams.

8. (canceled)

9. The process of claim 2, wherein all or a portion of said hydrogen stream is used as a stripping gas to extract CO₂ from the CO₂ selective solvent in the first separation zone including hydrogen in the third stream, comprising carbon dioxide, and reducing the amount of said hydrogen to generate the fourth stream.

10. The process of claim 2, wherein all or a portion of said hydrogen stream is used as a stripping gas to extract CO₂ from the CO₂ selective solvent in the second separation zone thus generating unreacted carbon dioxide RWGS stream and additional hydrogen.

11. (canceled)

12. (canceled)

13. (canceled)

14. The process of claim 1, where the carbon dioxide-to-carbon monoxide conversion unit is a CO₂ electrolysis unit or a CO₂+H2O co-electrolysis unit.

15. The process of claim 2, wherein the RWGS reactor is a heated catalytic multitube reactor design, an autothermal catalytic reactor, a fixed bed adiabatic catalytic reactor, or a combination thereof.

16. (canceled)

17. The process of claim 2, wherein the RWGS reactor is a high temperature autothermal POX type reactor, with no catalyst.

18. The process of claim 1, where said first synthesis gas stream is produced from partial oxidation, gasification and/or reforming of a carbonaceous feedstocks.

19. The process of claim 18, wherein the carbonaceous material comprises a plastic, a metal, an inorganic salt, an organic compound, industrial wastes, recycling facilities rejects, automobile fluff, municipal solid waste, ICI waste, C&D waste, refuse derived fuel (RDF), solid recovered fuel, sewage sludge, used electrical transmission pole, railroad ties, wood, tire, synthetic textile, carpet, synthetic rubber, materials of fossil fuel origin, expended polystyrene, poly-film floc, construction wood material, or any combination thereof.

20. (canceled)

21. (canceled)

22. The process of claim 1, further comprising admixing to the third stream an external input of CO₂ or CO₂ input obtained from a process effluent, increasing the CO₂ flow rate upstream of the CO₂ to CO conversion unit thereby, increasing the flow rate of CO in the syngas product stream, or further comprising admixing to the third stream a reformed low carbon intensity (CI) carbon rich stream, increasing the carbon content upstream of the CO₂ to CO conversion unit thereby, increasing the flow rate of CO in the syngas product stream.

23. (canceled)

24. The process of claim 23, where the carbon rich stream is a waste gas or liquid from the product synthesis unit; or the carbon rich stream is a gas or liquid from an external source.

25. (canceled)

26. The process of claim 23, where the carbon rich stream is reformed or partially oxidized at high temperature upstream of the RWGS unit producing additional syngas, and wherein the hot reformed waste stream is mixed at the inlet of the RWGS unit to provide all or part of the heat required for the endothermic RWGS reactor, reducing the energy requirement of the process.

27. The process of claim 26, wherein the carbon rich stream is reformed at more than 900° ° C. upstream of the RWGS unit

28. The process of claim 26, where the reforming step is conducted in a reforming unit.

29. (canceled)

30. A process for increasing production of carbon monoxide (CO) and recycling carbon dioxide when treating synthesis gas comprising the steps of:
a. gasifying a carbonaceous material in a fluidized bed, producing a classified crude syngas;
b. reforming said classified crude syngas at a temperature above mineral melting point, producing reformed synthesis gas comprising hydrogen, carbon monoxide and carbon dioxide;
c. passing said reformed synthesis gas through a first separation zone, thereby separating said first synthesis gas stream into a second stream comprising hydrogen and carbon monoxide, and a third stream comprising carbon dioxide; and
d. recycling said third stream comprising carbon dioxide to said fluidized bed gasifier, with or without steam and/or O₂ to reduce said reformed synthesis gas H₂/CO ratio, and increasing the total CO yield and production.

31-48. (canceled)
